(19) United States
(12) Patent Application Publication
(10) Pub. No.: US 2026/0228910 A1
(43) Pub. Date: Aug. 6, 2026

(54) MULTI-LEVEL LOCAL FEATURE DETECTION AND EXTRACTION

(71) Applicant: QUALCOMM Incorporated, San Diego, CA (US)

(72) Inventors: Iago SUAREZ, Madrid (ES); Andrii MAIDAN, Madrid (ES); Kostiantyn ANTONIUK, Kyiv (UA); Maksym RAITAROVSKYI, Madrid (ES)

(21) Appl. No.: 19/042,821

(22) Filed: Jan. 31, 2025

(51) Int. Cl. G06T 7/73; G06T 3/4046

(52) U.S. Cl. CPC G06T 7/74; G06T 3/4046; G06T 2207/20016; G06T 2207/20076; G06T 2207/20084; G06T 2207/30244

(57) ABSTRACT

The present disclosure provides techniques for feature detection and extraction. An example method includes obtaining a downsampled image comprising first pixels at a first resolution that is less than a second resolution; generating, with a neural network, for each pixel of the first pixels, a first respective probability that the pixel is a key point; upsampling the downsampled image to a second image comprising second pixels at a third resolution that is greater than the first resolution, wherein each pixel of the second pixels is associated with a corresponding pixel of the first pixels and the first respective probability associated with the corresponding pixel; generating, with the neural network, for each pixel of the second pixels for which the associated first respective probability is greater than a threshold probability, a second respective probability that the pixel is a key point; extracting a respective descriptor; and executing a localization task.

### FIELD OF THE DISCLOSURE

Aspects of the present disclosure relate to feature detection and extraction techniques for images.

### DESCRIPTION OF RELATED ART

Sensors are useful in apparatuses, such as extended reality devices, autonomous vehicles, robotic systems, and the like. Sensors enable perception of an environment, which may be useful for localization for path planning, decision making, object detection, object identification, and numerous other operations. Numerous sensors, such as a plurality of image sensors can be utilized to sense the environment and generate image data corresponding to the environment. Features captured in the image data may be extracted and utilized for localization processes. Localization processes enable an apparatus, such as an extended reality device, to determine its particular place within the environment. Such processes may analyze image data and extract features from the image data. Localization processes may then perform cross-view matching or a similar process between the extracted features from each of a plurality of images associated with different image sensors. Cross-view matching may include information regarding the relative position of each image sensor with respect to each other in order to accurately conduct localization processes. For example, the relative position of the image sensors with respect to each other allows for triangulation and the creation of a 3D map by comparing the perspective differences between multiple cameras, essentially enabling the system to pinpoint a location more precisely by combining information from different viewpoints.

There is a need for techniques that continue to improve feature extraction processes from image data, especially as localization processes are deployed on mobile devices such as extended reality headsets and eyewear where computation and memory resources may be limited.

### SUMMARY

Certain aspects provide a method for feature detection and extraction by an apparatus. The method includes obtaining a downsampled image of an image of an environment, wherein the downsampled image comprises a plurality of first pixels at a first resolution that is less than a second resolution of the image; generating, with a neural network, for each pixel of the plurality of first pixels, a first respective probability that the pixel is a key point; upsampling the downsampled image to a second image comprising a plurality of second pixels at a third resolution that is greater than the first resolution, wherein each pixel of the plurality of second pixels is associated with a corresponding pixel of the plurality of first pixels and the first respective probability associated with the corresponding pixel; generating, with the neural network, for each pixel of the plurality of second pixels for which the associated first respective probability is greater than a threshold probability, a second respective probability that the pixel is a key point; extracting, for one or more second pixels of the plurality of second pixels for which the associated second respective probability is greater than the threshold probability, a respective descriptor; and executing a localization task configured to utilize the respective descriptor of each of the one or more second pixels.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an illustrative indoor environment where an extended reality device is being utilized.

FIG. 2 depicts an illustrative sensor and computing system equipped apparatus, such as an extended reality device.

FIG. 3 depicts an illustrative block diagram of an architecture for implementing feature detection and extraction techniques.

FIG. 4 depicts aspects of an example method for feature detection and extraction techniques for images.

FIG. 5 depicts aspects of an example apparatus for feature detection and extraction techniques for images.

### DETAILED DESCRIPTION

Aspects of the present disclosure provide apparatuses, methods, processing systems, and computer-readable mediums related to feature detection and extraction techniques. More specifically, techniques described herein provide technical solutions for feature detection and feature extraction from images that provide the technical benefit of performing such processes with a reduced amount of computational resources and memory storage resources. An additional technical benefit includes a reduction in feature detection and feature extraction time through a multi-level feature detection and extraction process that excludes portions (e.g., pixels) of images from further processing that do not include interesting key points, which will be described in more detail herein. In other words, the multi-level feature detection and extraction process may only further process portions of an image that are determined to potentially have relevant detail, such as key points.

In certain aspects, key points refer to pixels or groups of pixels within an image that may have a significantly different pixel value with respect to neighboring pixel values. As used herein, the term significantly different pixel value may refer to a value that indicates how different a pixel value should be from one or more of the pixel values of its neighboring pixels to be considered as a potentially relevant key point. A pixel value may be defined by the color value of the pixel. It should be understood that color is only one element that may be considered in the pixel value of a pixel. Other elements that define the pixel value may include, but are not limited to, contrast of a pixel, intensity of the pixel, or the like. Differences between pixel values within an image tend to arise in the presence of edges, corners, textures, or other salient points of objects that are captured in the image data. For example, an image of a table within a room may have pixels that are key points corresponding to portions of the image that depict the legs and edges of the table surface as these portions of the table may have distinct colors, contrast, and/or intensities (e.g., pixel values) with respect to the background of the room, such as the floor, walls, and ceiling.

A need for improving feature detection and feature extraction techniques arises, in part, because mobile apparatus, such as extended reality (XR) devices may have limited computation resources and memory storage resources which can be allocated to tasks such as localization. Localization tasks, which may also be referred to as spatial positioning, are foundational tasks for the operation of extended reality devices. That is, methods for spatial positioning rely on feature detection and feature extraction. Feature detection and feature extraction is the process of finding key points, (e.g., salient points) and describing the key points using a multidimensional vector called a descriptor. For extended reality devices, the feature detection and feature extraction process needs to be fast (e.g., low latency) and low power. Extended reality devices, such as XR headsets and XR eyewear, typically include a plurality of image sensors configured to capture image data of an environment from multiple view perspectives. For example, some extended reality devices include 2, 3, 4, 5, 6, or possibly more image sensors. Implementation of multiple image sensors increases the computational load and memory storage requirements for detecting and extracting features as each image from the multiple image sensors are analyzed when executing current localization tasks.

For example, an extended reality device includes two or more image sensors that capture image data of the environment around the extended reality device. Extended reality devices use image data for localizing the device in the environment. That is, other methods of localization, such as the use of global positioning data may not be available in certain instances, such as in indoor environments. Each of the captured images are processed with feature detection and feature extraction processes. Current feature detection and feature extraction processes generally analyze full resolution image data, for example, 640 pixels by 480 pixels. Even at the example resolution, the computation resources required for continuous repeated analysis of a continuous sequence of images can be challenging to implement in devices such as extended reality devices. The continuous sequence of images is needed to maintain positioning of the extended reality device in the environment. Additionally, the computation time for continuous repeated analysis of the sequence of images may lead to delays in providing the localization task with extracted features, thus leading to delays in determining the position of the extended reality device in the environment.

Some techniques to reduce the computation costs of extracting features include detecting and extracting features from images obtained from a select number of the plurality of image sensors that is less than all of the image sensors. In such an implementation, when multiple image sensors observe the same key point, the feature detection and extraction process can be configured to detect features from two image sensors that view the same key point, rather than all of the image sensor that view the same key point.

Some other techniques to reduce the computation costs of extracting features include ignoring regions such as regions that do not contain useful information, such as empty walls, or regions that contain unwanted information, such as dynamic features including human beings or other moving objects. One way of ignoring such regions include masking them out. However, masking out the regions does not reduce the computation costs since the feature detection and extraction process, implementing a deep neural network for example, will still process all image pixels, even though the masked-out regions will not yield any features that define key points.

Some other techniques to reduce the computation costs of extracting features include processing a lower resolution image of the image data and extracting features from the lower resolution image. However, this process may result in inaccurate localization because some keypoints are invisible to detection at lower resolution.

Aspects of the present disclosure provide feature detection and extraction techniques that implement a cascade method. In brief, a low resolution image is initially processed with a machine learning (ML) model, such as a convolutional neural network (CNN), configured to detect and extract features. If no features (e.g., interesting objects expressed as key points) are detected, processing the image to detect and extract features may be stopped. Conversely, if one or more features are detected, then the image may be upsampled (e.g., the resolution is increased) and the increased resolution image is again processed by the ML model. Furthermore, the pixels that are not associated with the one or more features that are detected in the low resolution image are excluded from processing at the next, increased resolution image processing by the ML model. As described in more detail herein, the cascade approach, implemented in the feature detection and extraction process, uses a coarse-to-fine approach that eliminates pixels that do not include features (e.g., potential key points) from the feature detection and extraction process at the next, increased resolution image processing by the ML model. These feature detection and extraction techniques may enable an apparatus such as the extended reality device to efficiently detect and describe key points in multiple images, while reducing computational costs and balancing computational cost and accuracy.

Certain aspects will now described in more detail with reference to the figures.

### Extended Reality in an Environment

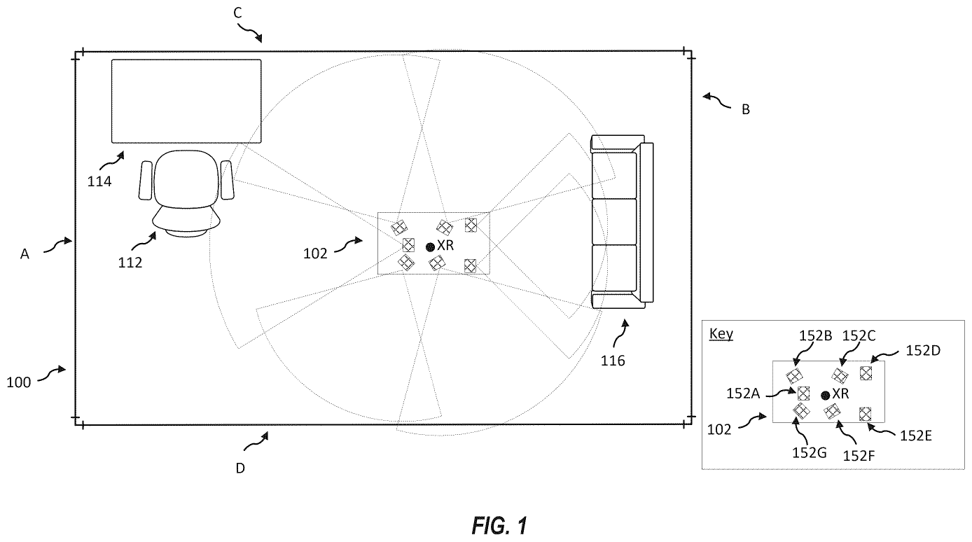

FIG. 1 depicts an illustrative indoor environment 100. The indoor environment 100 includes an extended reality device 102 that is being utilized, for example, by a user. The extended reality device 102 may be equipped with a plurality of sensors, such as a plurality of image sensors 152A-152F to capture images of the indoor environment to carry out various tasks such as localization of the extended reality device 102 within the indoor environment 100. Localization through image data may be utilized in indoor environments since global positioning data is typically unavailable since signals are blocked by the structure of the environment.

Extended reality is a general term that refers to augmented reality (AR), mixed reality (MR), and virtual reality (VR). The technology is intended to combine or mirror the physical world with a “digital twin world” that is able to be interacted with through the extended reality device, thus giving users an immersive experience of being in a virtual or augmented environment. Extended reality works by using visual data acquisition that is either accessed locally or shared and transferred over a network and to the human senses, for example through a headset or eyewear. By enabling real-time responses in a virtual stimulus these devices create customized experiences. As used herein, the term “real-time” refers to events occurring perceivably instantaneously or at once. Accordingly, computation time for generating virtual stimulus and aligning the stimulus with the visualized real-world environment needs to be very fast, such that a user does not perceive a delay. In view of this requirement, there is a balance that needs to be struck between computational resources and memory resources deployed in the extended reality device 102 and the resources required to carry out tasks such as feature detection and extraction that support other tasks such as localization of the extended reality device 102 in the indoor environment 100.

The illustrative indoor environment 100 depicted in FIG. 1 depicts a room with a chair 112, a desk 114, and a sofa 116. The room is enclosed by four walls A, B, C, D. An extended reality device 102 is being utilized within the room. The extended reality device 102 includes a plurality of image sensors 152A-152F. Each of the plurality of image sensors 152A-152F may each have a corresponding field of view illustratively depicted by the dashed lined fields. As illustratively depicted, portions of the field of views corresponding to the plurality of image sensors 152A-152 may overlap, thus in some situations two or more image sensors can capture image data of the same portion of the environment, albeit from different perspectives. The relative position of each image sensor on the extended reality device 102 is known and each field of view may be calibrated and fixed, so that localization tasks may utilize this information when matching key points between images obtained by different image sensors.

It should be understood that while the illustrative example discussed herein includes an extended reality device 102 being utilized in an indoor environment 100, the feature detection and extraction techniques described herein may be implemented on various apparatuses such as a robot operating in a facility, a vehicle traversing an indoor or outdoor environment, or other apparatus that utilizes features extracted from image data for performing tasks. Additionally, in certain aspects, the techniques described herein may be implemented on one or more various apparatuses separate from the apparatus configured with sensors to collect image data of the environment.

Given the indoor environment 100 depicted in FIG. 1, specific aspects will be described herein.

### Sensor and Computing System Equipped Apparatus

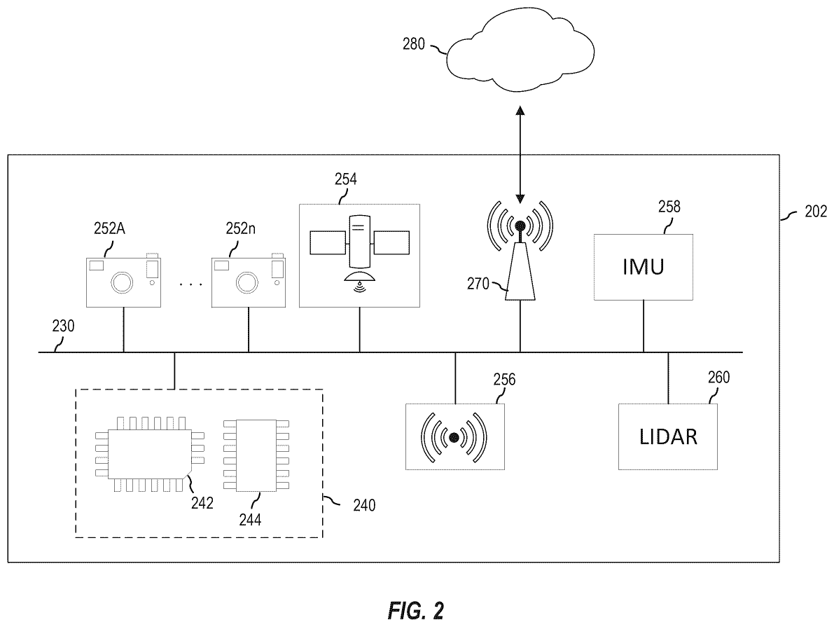

FIG. 2 depicts an illustrative sensor and computing system equipped apparatus 202, such as the extended reality device 102 depicted in FIG. 1, corresponding to aspects described herein. The apparatus 202 depicted in FIG. 2 is depicted by way of an example schematic of an extended reality device including sensor resources and a computing device. Not every extended reality device is required to be equipped with the same set of sensor resources, nor is every extended reality device required to be configured with the same set of systems for perceiving attributes of an environment. FIG. 2 only provides one example configuration of sensor resources and systems equipped within an extended reality device.

In particular, FIG. 2 provides an example schematic of apparatus 202 including a variety of sensor resources, which may be utilized by the apparatus 202 to perceive and collect sensor data about the environment. For example, the apparatus 202 may include a computing device 240 comprising one or more processors 242 and a non-transitory computer readable memory 244 (also referred to herein as one or more memories), one or more image sensors 252A-252n, a Global Positioning System (GPS) unit 254, a radar system 256, an inertial measurement unit (IMU) 258, a light detection and ranging (LiDAR) system 260, and network interface hardware 270. The aforementioned components of the apparatus are merely examples as some apparatuses may have more or less components and/or different sensors for perceiving the environment. These and other components of the apparatus 202 may be communicatively connected to each other via a communication path 230. It should be noted that non-transitory computer readable memory 244 may include volatile and/or non-volatile memory or storage.

The communication path 230 may be formed from any medium that is capable of transmitting a signal such as, for example, conductive wires, conductive traces, optical waveguides, or the like. The communication path 230 may also refer to the expanse in which electromagnetic radiation and their corresponding electromagnetic waves traverse. Moreover, the communication path 230 may be formed from a combination of mediums capable of transmitting signals. In some aspects, the communication path 230 comprises a combination of conductive traces, conductive wires, connectors, and buses that cooperate to permit the transmission of electrical data signals to components such as processors, memories, sensors, input devices, output devices, and communication devices. Accordingly, the communication path 230 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 240 may be any device or combination of components comprising one or more processors 242 and non-transitory computer readable memory, referred to herein as one or more memories 244. The one or more processors 242 may be any device capable of executing the processor-executable instructions stored in the one or more memories 244. Accordingly, the one or more processors 242 may be an electric controller, an integrated circuit, a microchip, a computer, or any other computing device. The one or more processors 242 are communicatively coupled to the other components of the apparatus 202 by the communication path 230. Accordingly, the communication path 230 may communicatively couple any number of processors 242 with one another, and allow the components coupled to the communication path 230 to operate in a distributed computing environment. Specifically, each of the components may operate as a node that may send and/or receive data.

The one or more memories 244 may comprise random access memory (RAM), read-only memory (ROM), flash memories, hard drives, or any non-transitory memory device capable of storing processor-executable instructions such that the processor-executable instructions can be accessed and executed by the one or more processors 242. The machine-readable instruction set may comprise logic or algorithm(s) written in any programming language of any generation (e.g., 1 GL, 2 GL, 3 GL, 4 GL, or 5 GL) such as, for example, machine language that may be directly executed by the one or more processors 242, or assembly language, object-oriented programming (OOP), scripting languages, microcode, etc., that may be compiled or assembled into processor-executable instructions and stored in the one or more memories 244. Alternatively, the processor-executable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. The one or more processors 242 and the one or more memories 244 may be collectively referred to herein as a processing system. A processing system may additionally include one or more other components of FIG. 2.

The apparatus 202 may further include one or more image sensors 252A-252n. The one or more image sensors 252A-252n may be any device having an array of sensing devices (e.g., a CCD array or active pixel sensors) capable of detecting radiation in an ultraviolet wavelength band, a visible light wavelength band, or an infrared wavelength band. The one or more image sensors 252A-252n may have any resolution. The one or more image sensors 252A-252n may include an omni-direction camera and/or a panoramic camera. In some aspects, one or more optical components, such as a mirror, fish-eye lens, or any other type of lens may be optically coupled to the image sensors 252A-252n. The image data collected by the image sensors 252A-252n may be stored in the one or more memories 244.

Still referring to FIG. 2, a GPS unit 254 may be coupled to the communication path 230 and communicatively coupled to the computing device 240 of the apparatus 202. The GPS unit 254 is capable of generating location information indicative of a location of the apparatus 202 by receiving one or more GPS signals from one or more GPS satellites. The GPS signal communicated to the computing device 240 via the communication path 230 may include location information comprising a National Marine Electronics Association (NMEA) message, a latitude and longitude data set, a street address, a name of a known location based on a location database, or the like. Additionally, the GPS unit 254 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS unit 254 may be stored in the one or more memories 244.

The apparatus 202 may also include a radar system 256. The radar system 256 measures the distance to objects over wide distances. It is also possible to measure the relative speed of the detected object. The radar system 256 may be a continuous wave (CW), frequency-modulated continuous wave (FMCW), 3D-radar (such as 3D FMCW multiple-input and multiple-output (MIMO)), or 4D-radar (such as 4D FMCW MIMO). The sensor data collected by the radar system 256 may be stored in the one or more memories 244.

The apparatus 202 may include an inertial measurement unit (IMU) 258. The IMU 258 is an electronic device that measures and reports an apparatus's specific force, angular rate, and sometimes the orientation of the apparatus, using a combination of accelerometers, gyroscopes, and sometimes magnetometers. The sensor data collected by the IMU 258 may be stored in the one or more memories 244.

In some aspects, the apparatus 202 may include a LiDAR system 260. The LiDAR system 260 is communicatively coupled to the communication path 230 and the computing device 240. A LiDAR system 260 is a system and method of using pulsed laser light to measure distances from the LiDAR system 260 to objects that reflect the pulsed laser light. A LiDAR system 260 may be made as solid-state devices with few or no moving parts, including those configured as optical phased array devices where prism-like operation permits a wide field-of-view without the weight and size complexities associated with a traditional rotating LiDAR system 260. The LiDAR system 260 is particularly suited to measuring time-of-flight, which in turn can be correlated to distance measurements with objects that are within a field-of-view of the LiDAR system 260. By calculating the difference in return time of the various wavelengths of the pulsed laser light emitted by the LiDAR system 260, a digital 3D representation of a target or environment may be generated. The pulsed laser light emitted by the LiDAR system 260 includes emissions operated in or near the infrared range of the electromagnetic spectrum, for example, having emitted radiation of about 905 nanometers. Sensors such as the LiDAR system 260 can be used by XR devices to provide detailed 3D spatial information for the identification of objects near the apparatus 202, as well as the use of such information in the service of systems for spatial mapping, navigation and autonomous operations, especially when used in conjunction with geo-referencing devices such as GPS unit 254 or a gyroscope-based inertial navigation unit (INU, not shown or IMU 258) or related dead-reckoning system. The point cloud data collected by the LiDAR system 260 may be stored in the one or more memories 244.

Still referring to FIG. 2, apparatuses, such as XR devices, can be equipped with communication systems. Some of the communication systems rely on network interface hardware 270. The network interface hardware 270 may be coupled to the communication path 230 and communicatively coupled to the computing device 240. The network interface hardware 270 may be any device capable of transmitting and/or receiving data with a network 280 or directly with another XR device. Accordingly, network interface hardware 270 can include a communication transceiver for sending and/or receiving any wired or wireless communication. For example, the network interface hardware 270 may include an antenna, a modem, LAN port, Wi-Fi card, WiMax card, mobile communications hardware, near-field communication hardware, satellite communication hardware and/or any wired or wireless hardware for communicating with other networks and/or devices. In some aspects, network interface hardware 270 includes hardware configured to operate in accordance with the Bluetooth wireless communication protocol. In some aspects, network interface hardware 270 may include a Bluetooth send/receive module for sending and receiving Bluetooth communications to/from a network 280 and/or another XR device. In some aspects, the network interface hardware 270 may implement a radio access technology (RAT) such as a 5G or 6G RAT. For example, the network interface hardware 270 may provide apparatus-to-apparatus (A2A) connectivity, access network connectivity, sidelink connectivity (e.g., using a PC5 interface), or the like.

### Aspects Related to Adaptive Feature Detection and Extraction

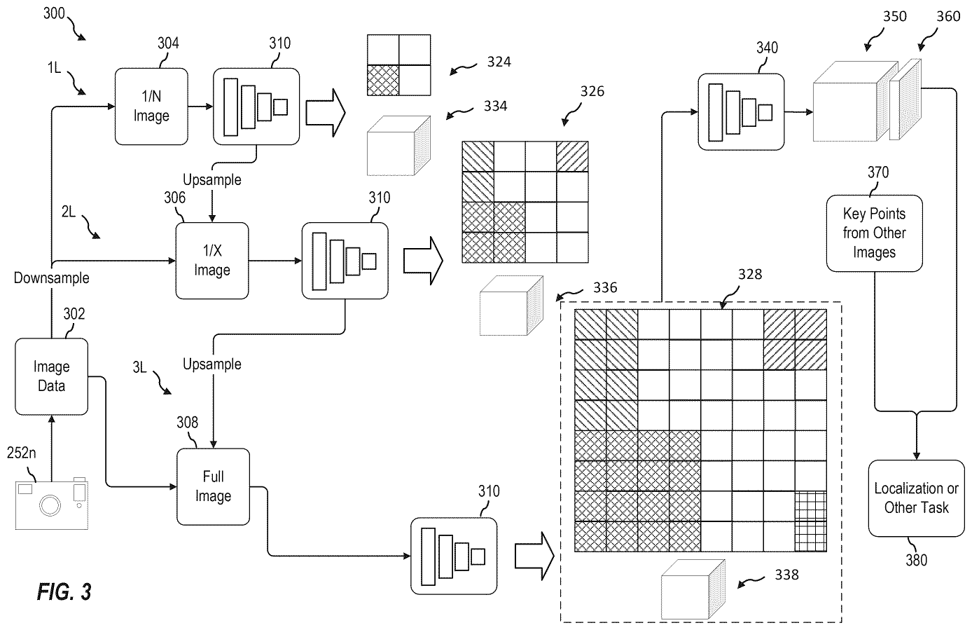

FIG. 3 depicts an illustrative block diagram of an architecture 300 for feature detection and extraction techniques for images. The architecture 300 may be implemented as software and/or hardware, such as the computing device 240 comprising one or more processors 242 and a non-transitory computer readable memory 244 shown for example in FIG. 2 (e.g., a processing system). The architecture 300 includes several components which will be described herein. The architecture 300 provides a cascade-type coarse-to-fine approach to feature detection and extraction from an image. The architecture 300 can be duplicated and implemented, for example, in parallel, for image data generated by each respective image sensor on the apparatus 202 (e.g., the extended reality device 102). Additionally, while the architecture 300 depicted in FIG. 3 include 3 levels, this is merely for purposes of explanation. It should be understood that the architecture may include less than three or more than three levels. As discussed herein, various aspects of the architecture 300 may be implemented exclusively with hardware or a combination of hardware and software. For example, in certain aspects, downsampling and/or upsampling image data may be a hardware implemented task.

In certain aspects, the architecture 300 is configured to obtain image data 302, for example, from an image sensor 252n of a plurality of image sensors 252 implemented on the apparatus 202. In some aspects, the image data 302 may be obtained directly from the image sensor 252n, while in other aspects the image data 302 may be obtained from a memory component of the apparatus. The obtained image data 302 may have a resolution that corresponds to the image sensor 252n. For example, the obtained image data 302 may have a resolution of 640 pixels by 480 pixels. For purposes of explanation herein, the resolution that corresponds to the image sensor 252n, from which the image was generated, is referred to as the full resolution.

The architecture 300 include a hardware and/or software based downsampling process that reduces the resolution of the obtained image data 302 to a downsampled resolution (e.g., a first resolution) that is less than the full resolution (e.g., a second resolution) of the obtained image data 302. Downsampling is the reduction in spatial resolution while keeping the same two-dimensional (2D) representation. Downsampling reduces an image's resolution by discarding pixels. A downsampling process may include a uniform reduction in pixels, for example, each grouping of four pixels may be reduced to one pixel. In this way, the pixel value from each of four pixels may be combined into one pixel may be averaged together to generate the pixel value for the resulting pixel, for example, as done by a box sampling method. The number of pixels that are combined may be configured to achieve a desired resolution (e.g., 1/N image resolution) of the downsampled image 304. There are several known methods of downsampling, for example, including but not limited to decimation, box sampling, reservoir sampling, and others. It should be understood that one of the various methods of downsampling may be implemented in the architecture 300 described herein. Furthermore, when an upsampling method is utilized, as discussed herein, the upsampling method may correspond to the downsampling method that was utilized.

A neural network 310 is configured to receive the downsampled image 304. The neural network 310 is configured to process the downsampled image 304 and generate a probability for each of the pixels in the downsampled image 304 that corresponds to a likelihood that the pixel is a key point. The neural network 310 may express the probabilities in the form of a heatmap. The heatmap may be a data representation, such as a matrix having a size and shape that matches the resolution of the downsampled image. Each value within the matrix may be the probability generated by the neural network that the corresponding pixel is a key point. In some aspects, a visual representation of the heatmap may be generated as an output. In such instances, a color palette may be correlated to each probability value such that the visual representation of the heatmap may comprise specific colors for each pixel based on the probability of each pixel.

In certain aspects, the neural network 310 or a post process that receives the probability for each pixel generated by the neural network 310 may be configured to compare the probability to a threshold probability. The threshold probability may be defined to convert the range of probabilities, for example, a number between 0 and 1 (e.g., 0% to 100%) to a binary indicator that the pixel is or is not likely to be a key point. For example, the threshold probability may be set to a value of 0.7. Accordingly, any pixel with a probability of 0.7 or greater may be assigned a value of +1 and any pixel with a probability of less than 0.7 may be assigned a value of −1. These values may replace the discrete probability values in the heatmap that is generated by the neural network.

The architecture 300 is configured to further consider only the pixels that have a value of +1 or, if not converted to a binary indicator, a probability that is equal to or greater than the threshold probability in the next level of the feature detection and extraction process. For example, as depicted in FIG. 3, the visual representation of the first heatmap 324 has a resolution of two by two pixels. The lower left pixel, which is depicted with a crosshatch pattern, was determined to have a probability that was less than the threshold probability. Accordingly, this pixel will not be considered in the next level of the architecture 300. This is different from the masking-out process discussed hereinabove, because in a masking-out process the information related to the pixel, such as the pixel value may be, for example set to zero, but the pixel continues to be considered in a later coarse-to-fine process. That is, there is no computational cost savings by masking-out the pixel, since the pixel is still considered in the feature detection and extraction process. However, in the architecture 300, the pixels that have a probability that is less than the threshold probability are excluded from further processing, which reduces the computational resources by not processing pixels that have not interesting information such as key points used for a localization task.

In certain aspects, the neural network 310 may also generate a three-dimensional (3D) tensor 334 corresponding to the downsampled image 304 that was processed by the neural network 310. A tensor is a mathematical object that describes linear relationships between sets of multidimensional data. For example, tensors may be a generalization of scalars, vectors, and matrices. For example, a 3D tensor can be described as a cube of numbers, with each number representing a different element in the tensor. The 3D tensor 334 has a shape with a height and a width that corresponds to image height and image width of the downsampled image 304. The third dimension of the 3D tensor 334 is a color channel, such that each element in the 3D tensor represents a pixel of the downsampled image 304. In some aspects, the 3D tensor 334 may exclude pixels that have a probability that is less than the threshold probability.

In certain aspects, if the neural network 310 generates respective probabilities for each of the pixels in the downsampled image 304 that are all less than the threshold probability, then the feature detection and extraction process may be terminated for the present image. Implementation of the aforementioned determination has the technical effect of reducing or eliminating unnecessary computation of an image that is not likely to include a key point.

In certain aspects, the architecture 300 includes a second level (2 L). In the second level, the downsampled image 304 may be upsampled to a second image 306 comprising a plurality of second pixels at a third resolution (e.g., 1/M image resolution) that is greater than the downsampled resolution (e.g., the first resolution) of the downsampled image 304. In some aspects, the architecture 300 may also be configured to downsample the obtained image data 302 to the third resolution of the second image 306 and combine it with the second image 306 to maintain or improve image data of the second image 306, such as feature representations that may be lost during the upsampling process. Each pixel of the plurality of second pixels is associated with a corresponding pixel of the plurality of first pixels making up the downsampled image 304. In some aspects, the third resolution may be the full resolution (e.g., the second resolution) or may be a resolution that is less than the full resolution. The second level also obtains the probability for each pixel of the plurality of first pixels of the downsampled image 304 and may directly exclude the upsampled pixels that correspond to pixels of the downsampled image 304 having a probability that is less than the threshold probability.

Upsampling methods utilized in the present architecture may include bilinear upsampling or nearest neighbor upsampling, for example. The architecture may utilize other methods of upsampling to convert the downsampled image and the corresponding heatmap into an upsampled version.

For example, as depicted in FIG. 3, each pixel in the downsampled image 304, as depicted by the first heatmap 324 is upsampled to a box of four pixels in the second image 306 as depicted by the second heatmap 326. As shown in the second heatmap 326, the box of four pixels in the lower left corner are directly illustrated with cross-hatching as they correspond to the pixel in the lower left corner of the first heatmap 324 that was found to have a probability that is less than the threshold probability. Accordingly, the pixels that are indicated by the cross-hatching are excluded from processing by the neural network 310 in the second level of the architecture. It is understood that the neural network 310 utilized at each level of the architecture 300 may be the same neural network that is utilized iteratively as the neural network is configured with the same task of ingesting image data and generating respective probabilities for each of the pixels as to whether the pixel is a key point. However, in some embodiments, a different neural network may be utilized at one or more of the levels of the architecture 300.

The second image 306, which has been upsampled from downsampled image 304 and where pixels determined not to likely be a keypoint have been excluded, is processed by the neural network 310 in the second level. The neural network 310 generates, for each pixel of the plurality of second pixels for which the associated first respective probability is greater than a threshold probability, a second respective probability that the pixel is a key point. That is, the neural network generates a probability for each of the pixels in the second image except for the excluded pixels (e.g., those pixels illustrated with cross-hatching in the second heatmap 326). In the illustrative example depicted with architecture 300, the neural network 310 generates the second heatmap 326. The second level of the architecture 300 has further determined that two pixels in the upper left of the second image (shown with top-left to bottom-right diagonal lines) have a second respective probability that is less than the threshold probability. Additionally, second level of the architecture 300 has further determined that a pixel in the upper right of the second image (shown with bottom-left to top-right diagonal lines) has a second respective probability that is less than the threshold probability. These three additional pixels are excluded from further feature detection and extraction processing.

In certain aspects, the threshold probability for each level of the architecture 300 may be the same or may be different between levels. In some aspects, the architecture 300 may include two levels, but in other instances the architecture may include two or more levels. The number of levels may be configured from implementation to implementation based on the needs for detecting and extracting features from image data.

In certain aspects, the neural network 310 may also generate a second 3D tensor 336 corresponding to the second image 306 that was processed by the neural network 310. The second 3D tensor 336 has a shape with a height and a width that corresponds to image height and image width of the second image 306. The third dimension of the second 3D tensor 336 is a color channel, such that each element in the second 3D tensor 336 represents a pixel of the second image 306. In some aspects, the second 3D tensor 336 may exclude pixels that have a second respective probability that is less than the threshold probability.

In certain aspects, the architecture 300 includes a third level (3 L). In the third level, the second image 306 may be upsampled to a third image 308 comprising a plurality of third pixels at a fourth resolution that is greater than the downsampled resolution (e.g., the first resolution) of the downsampled image 304 and the second resolution of the second image 306. In some aspects, the architecture 300 may also be configured to downsample the obtained image data 302 to the fourth resolution of the third image 308 and combine it with the third image 308 to maintain or improve image data of the third image 308, such as feature representations that may be lost during the upsampling process. Each pixel of the plurality of third pixels is associated with a corresponding pixel of the plurality of second pixels making up the second image 306. In some aspects, the fourth resolution may be the full resolution (e.g., the second resolution) or may be a resolution that is less than the full resolution. The third level also obtains the probability for each pixel of the plurality of second pixels of the second image 306 and may directly exclude the upsampled pixels that correspond to pixels of the second image 306 having a probability that is less than the threshold probability.

For example, as depicted in FIG. 3, each pixel in the second image 306, as depicted by the second heatmap 326 is upsampled to a box of four pixels in the third image 308 (e.g., the full image) as depicted by the third heatmap 328. As shown in the third heatmap 328, the box of 16 pixels in the lower left corner are illustrated with cross-hatching as they correspond to the box of four pixels in the lower left corner of the second heatmap 326 that was found to have a probability that is less than the threshold probability. Accordingly, the pixels that are indicated by the cross-hatching are excluded from processing by the neural network 310 in the third level of the architecture 300.

The third image 308, which has been upsampled from second image 306 and where pixels determined not to likely be a keypoint have been excluded, is processed by the neural network 310 in the third level. The neural network 310 generates, for each pixel of the plurality of third pixels for which the associated second respective probability is greater than a threshold probability, a third respective probability that the pixel is a key point. That is, the neural network 310 generates a probability for each of the pixels in the third image except for the excluded pixels (e.g., those pixels illustrated with cross-hatching, top-left to bottom-right diagonal lines, and bottom-left to top-right diagonal lines in the second heatmap 326). In the illustrative example depicted with architecture 300, the neural network 310 generates the third heatmap 328. The third level of the architecture 300 has further determined that two pixels in the bottom right of the third image (shown with grid patterned lines) have a third respective probability that is less than the threshold probability. These two additional pixels are excluded from further feature detection and extraction processing.

In certain aspects, the neural network 310 may also generate a third 3D tensor 338 corresponding to the third image 308 that was processed by the neural network 310. The third 3D tensor 338 has a shape with a height and a width that corresponds to image height and image width of the third image 308. The third dimension of the third 3D tensor 336 is a color channel, such that each element in the second 3D tensor 336 represents a pixel of the downsampled image 304. In some aspects, the second 3D tensor 336 may exclude pixels that have a third respective probability that is less than the threshold probability.

In certain aspects, the architecture 300 continues to cascade in a coarse-to-fine manner until the upsampled resolution of the image that is processed through the neural network is the full resolution image. However, in some aspects, the following architecture components may be implemented following one of the prior levels.

As depicted in the illustrative architecture 300 of FIG. 3, the third image at the third level is equivalent to the full resolution of the image. Additionally, the third heatmap and the third 3D tensor correspond to the third image. These respective outputs of the neural network 310 are further processed by one or more post-processing components to obtain respective descriptors for the key points so that the descriptors may be utilized for tasks such as localization tasks which obtain key points generated from other images having different perspectives (although not necessarily distinct perspectives) of the environment.

In certain aspects, the architecture 300 includes a salient location selection component. The salient sampler component may include a sampler that selects the most important locations from the third heatmap using a technique referred to as Non-Maximal Suppression (NMS). NMS helps in identifying the most prominent key points by suppressing weaker, non-maximum points around the stronger ones. This process may be an optional implemented in the architecture as a post process.

In certain aspects, the architecture 300 implements a descriptor extractor component 340 to extract a descriptor from the 3D tensor for pixels indicated by the heatmap to include a key point. For example, the descriptor extractor component 340 receives the third 3D tensor 338 and the third heatmap 328. The descriptor extractor component 340 may use bilinear interpolation to address locations in the 3D tensor 338 that correspond to the pixels in the third heatmap 328 indicated as likely including a key point. In certain aspects, the descriptor extractor component 340 extracts a 256-dimensional floating-point vector (e.g., descriptor) for each key point into a vector space 350. The descriptor may describe the key point such that the key point can be compared to key points extracted from other images and compared to during a localization task.

In some aspects, in order to make the descriptors more compact and easier to handle by tasks such as localization tasks, a hashing process may be implemented. For example, the extracted 256-dimensional vector is then binarized using the “sign function.” The sign function is a function that has the value of +1, −1, or 0 according to whether the sign of a given real number is positive, negative, or zero. This process converts the floating-point values (e.g., the extracted 256-dimensional vector) into binary values, making the descriptors more compact and easier to handle. The binary values are formatted into a hash 360.

The architecture 300 described herein may be implemented for a plurality of images captured by different image sensors having different perspectives of the environment. The key points and corresponding descriptors extracted for two or more sets of images can be further utilized for tasks such as localization tasks. The localization task 380 may be configured to receive key points and corresponding descriptors from other images 370 and further receive the key points and corresponding descriptors corresponding to the image data 302 (e.g., the third image 308). The localization task 380 may utilize one or more known localization techniques or yet to be determine techniques.

The architecture 300 when implemented by an apparatus, such as an extended reality device 102 may provide the technical benefit of reducing the computational cost of extracting features with a neural network by avoiding computation and processing of pixels that are determined at reduced resolutions as not including key points. For example, pixels associated with blank walls, ceilings, or floors or uniform surfaces such as table tops or the like may not include interesting features that may be utilized as a key point.

The coarse-to-fine approach may also allow the feature detection and extraction process to halt if at some point it is determined that there are no interesting key points in the image. Since the technique processes images from low to high resolution a small amount of computational resources are utilized on each decision.

### Example Operations

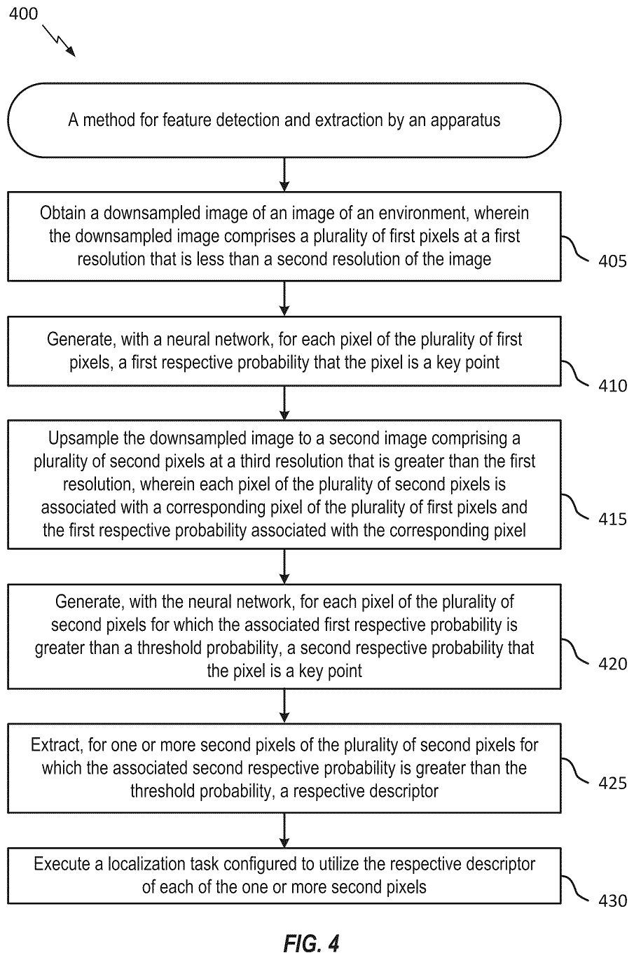

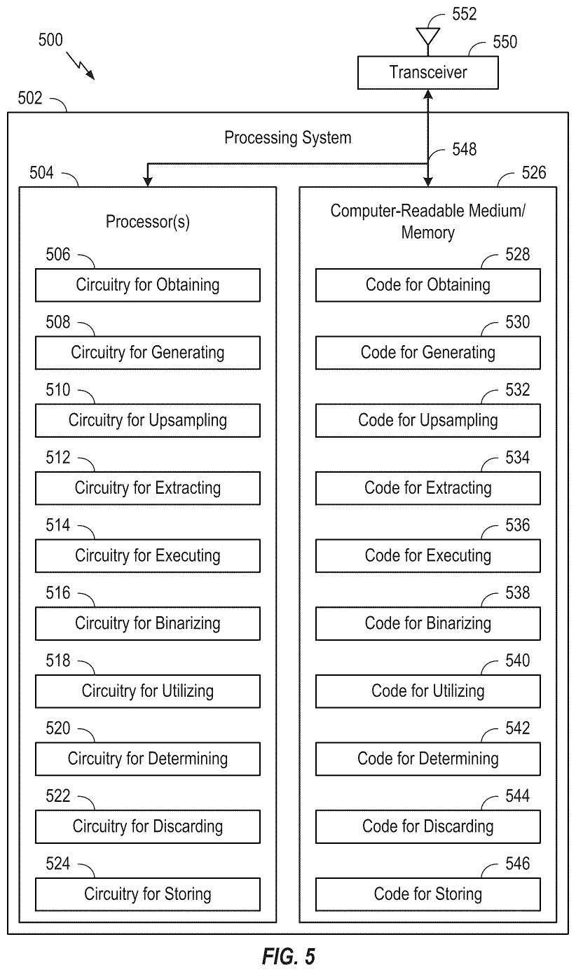

FIG. 4 shows an example method 400 for feature detection and extraction by an apparatus, such as extended reality device 102 of FIG. 1 or apparatus 202 of FIG. 2. Aspects of the method 400 can be implemented by the computing device 240 comprising one or more processors 242 and a non-transitory computer readable memory 244 shown for example in FIG. 2 and/or the apparatus 500 of FIG. 5.

Method 400 begins at block 405 with obtaining a downsampled image of an image of an environment, wherein the downsampled image comprises a plurality of first pixels at a first resolution that is less than a second resolution of the image.

Method 400 then proceeds to block 410 with generating, with a neural network, for each pixel of the plurality of first pixels, a first respective probability that the pixel is a key point.

Method 400 then proceeds to block 415 with upsampling the downsampled image to a second image comprising a plurality of second pixels at a third resolution that is greater than the first resolution, wherein each pixel of the plurality of second pixels is associated with a corresponding pixel of the plurality of first pixels and the first respective probability associated with the corresponding pixel.

Method 400 then proceeds to block 420 with generating, with the neural network, for each pixel of the plurality of second pixels for which the associated first respective probability is greater than a threshold probability, a second respective probability that the pixel is a key point.

Method 400 then proceeds to block 425 with extracting, for one or more second pixels of the plurality of second pixels for which the associated second respective probability is greater than the threshold probability, a respective descriptor.

Method 400 then proceeds to block 430 with executing a localization task configured to utilize the respective descriptor of each of the one or more second pixels.

In some aspects, method 400 further includes obtaining a map of the environment; and wherein the localization task is based on a comparison of the map of the environment to the second image and the respective descriptor of each of the one or more second pixels.

In some aspects, method 400 further includes obtaining a third image of the environment; and wherein the localization task is based on a comparison of the third image to the second image and the respective descriptor of each of the one or more second pixels.

In some aspects, method 400 further includes binarizing the respective descriptor of each of the one or more second pixels.

In some aspects, generating the first respective probability for each pixel of the plurality of first pixels comprises generating a heatmap of the downsampled image, wherein pixel values of the heatmap correspond to the first respective probability for each of the plurality of first pixels.

In some aspects, block 420 includes generating a second heatmap of the second image, wherein pixel values of the second heatmap correspond to the second respective probability of each of the plurality of second pixels for which the associated first respective probability is greater than the threshold probability.

In some aspects, method 400 further includes generating, with the neural network, a three-dimensional tensor for the second image, wherein the three-dimensional tensor comprises a shape with a height and a width corresponding to the third resolution, and a color channel, and block 425 includes utilizing bilinear interpolation of the three-dimensional tensor to extract the respective descriptor corresponding to each of the one or more second pixels.

In some aspects, the method 400 is performed by an apparatus comprising a plurality of image sensors communicatively coupled to one or more processors and one or more memories, wherein each of the plurality of image sensors are configured to generate respective image data of the environment from different perspectives. In some aspects, the method 400 further comprises: obtaining a second downsampled image of a third image associated with a different perspective of the environment than the image, wherein the second downsampled image comprises a plurality of third pixels at a fourth resolution that is less than a fifth resolution of the third image; generating, with the neural network, for each pixel of the plurality of third pixels, a third respective probability that the pixel is a key point; determining that the third respective probability of each of at least one of the plurality of third pixels is greater than the threshold probability or that the third respective probability of each of at least one of the plurality of third pixels is not greater than the threshold probability; and in response to a determination that the third respective probability of each of the at least one of the plurality of third pixels is not greater than the threshold probability, discarding the second downsampled image.

In some aspects, the method 400 is performed by an apparatus comprising a plurality of image sensors communicatively coupled to one or more processors and one or more memories, wherein each of the plurality of image sensors are configured to generate respective image data of the environment from different perspectives. In some aspects, the method 400 further comprises: obtaining a second downsampled image of a third image associated with a different perspective of the environment than the image, wherein the second downsampled image comprises a plurality of third pixels at a fourth resolution that is less than a fifth resolution of the third image; generating, with the neural network, for each pixel of the plurality of third pixels, a third respective probability that the pixel is a key point; determining that the third respective probability of each of at least one of the plurality of third pixels is not greater than the threshold probability; and in response to a determination that the third respective probability of the at least one of the plurality of third pixels is greater than the threshold probability: upsampling the second downsampled image to a fourth image comprising a plurality of fourth pixels that is greater than the third resolution, wherein each pixel of the plurality of fourth pixels is associated with a corresponding pixel of the plurality of third pixels and the third respective probability associated with the corresponding pixel; generating, with the neural network, for each pixel of the plurality of fourth pixels for which the associated third respective probability is greater than the threshold probability, a fourth respective probability that the pixel is a key point; extracting, for one or more fourth pixels of the plurality of fourth pixels for which the associated fourth respective probability is greater than the threshold probability, a respective descriptor; and storing the respective descriptor of each of the one or more fourth pixels in the one or more memories of the apparatus.

In some aspects, the third resolution is equivalent to the second resolution of the image.

In some aspects, method 400, or any aspect related to it, may be performed by an apparatus, such as apparatus 500 of FIG. 5, which includes various components operable, configured, or adapted to perform the method 400. Apparatus 500 is described below in further detail.

Note that FIG. 4 is just one example of a method, and other methods including fewer, additional, or alternative operations are possible consistent with this disclosure.

### Example Apparatus

FIG. 5 depicts aspects of an example apparatus 500 configured for feature detection and extraction, such as extended reality device 102 of FIG. 1 or apparatus 202 of FIG. 2. In some aspects, apparatus 500 is may be the computing device 240 comprising one or more processors 242 and a non-transitory computer readable memory 244 shown for example in FIG. 2.

The apparatus 500 includes a processing system 502 coupled to a transceiver 550 (e.g., a transmitter and/or a receiver). The transceiver 550 is configured to transmit and receive signals for the apparatus 500 via an antenna 552, such as the various signals as described herein. The processing system 502 may be configured to perform processing functions for the apparatus 500, including processing signals received and/or to be transmitted by the apparatus 500.

The processing system 502 includes one or more processors 504 and a computer-readable medium/memory 526. In various aspects, the one or more processors 504 may be representative of the one or more processors of a computing device. The one or more processors 504 are coupled to a computer-readable medium/memory 526 via a bus 548. In some aspects, the computer-readable medium/memory 526 may be representative of the one or more memories (e.g., the non-transitory computer readable memory 244 described with respect to FIG. 2). The computer-readable medium/memory 526 is a non-transitory computer-readable medium/memory. In certain aspects, the computer-readable medium/memory 526 is configured to store instructions (e.g., computer-executable code), that when executed by the one or more processors 504, cause the one or more processors 504 to perform the method 400 described with respect to FIG. 4, or any aspect related to it, including any operations described in relation to FIG. 4. Note that reference to a processor performing a function of apparatus 500 may include one or more processors performing that function of apparatus 500, such as in a distributed fashion.

In the depicted example, computer-readable medium/memory 526 stores code (e.g., executable instructions), including code for obtaining 528, code for generating 530, code for upsampling 532, code for extracting 534, code for executing 536, code for binarizing 538, code for utilizing 540, code for determining 542, code for discarding 544, and code for storing 546. Processing of the code 528-546 may enable and cause the apparatus 500 to perform the method 400 described with respect to FIG. 4, or any aspect related to it. For example, in some aspects, code for obtaining 528 includes code for obtaining a downsampled image of an image of an environment, wherein the downsampled image comprises a plurality of first pixels at a first resolution that is less than a second resolution of the image. In some aspects, code for generating 530 includes code for generating, with a neural network, for each pixel of the plurality of first pixels, a first respective probability that the pixel is a key point. In some aspects, code for upsampling 532 includes code for upsampling the downsampled image to a second image comprising a plurality of second pixels at a third resolution that is greater than the first resolution, wherein each pixel of the plurality of second pixels is associated with a corresponding pixel of the plurality of first pixels and the first respective probability associated with the corresponding pixel. In some aspects, code for generating 530 includes code for generating, with the neural network, for each pixel of the plurality of second pixels for which the associated first respective probability is greater than a threshold probability, a second respective probability that the pixel is a key point. In some aspects, code for extracting 534 includes code for extracting, for one or more second pixels of the plurality of second pixels for which the associated second respective probability is greater than the threshold probability, a respective descriptor. In some aspects, code for executing 536 includes code for executing a localization task configured to utilize the respective descriptor of each of the one or more second pixels.

The one or more processors 504 include circuitry configured to implement (e.g., execute) the code stored in the computer-readable medium/memory 526, including circuitry for obtaining 506, circuitry for generating 508, circuitry for upsampling 510, circuitry for extracting 512, circuitry for executing 514, circuitry for binarizing 516, circuitry for utilizing 518, circuitry for determining 520, circuitry for discarding 522, and circuitry for storing 524. Processing with circuitry 506-524 may enable and cause the apparatus 500 to perform the method 400 described with respect to FIG. 4, or any aspect related to it. For example, in some aspects, circuitry for obtaining 506 includes circuitry for obtaining a downsampled image of an image of an environment, wherein the downsampled image comprises a plurality of first pixels at a first resolution that is less than a second resolution of the image. In some aspects, circuitry for generating 508 includes circuitry for generating, with a neural network, for each pixel of the plurality of first pixels, a first respective probability that the pixel is a key point. In some aspects, circuitry for upsampling 510 includes circuitry for upsampling the downsampled image to a second image comprising a plurality of second pixels at a third resolution that is greater than the first resolution, wherein each pixel of the plurality of second pixels is associated with a corresponding pixel of the plurality of first pixels and the first respective probability associated with the corresponding pixel. In some aspects, circuitry for generating 508 includes circuitry for generating, with the neural network, for each pixel of the plurality of second pixels for which the associated first respective probability is greater than a threshold probability, a second respective probability that the pixel is a key point. In some aspects, circuitry for extracting 512 includes circuitry for extracting, for one or more second pixels of the plurality of second pixels for which the associated second respective probability is greater than the threshold probability, a respective descriptor. In some aspects, circuitry for executing 514 includes circuitry for executing a localization task configured to utilize the respective descriptor of each of the one or more second pixels.

More generally, means for communicating, transmitting, sending or outputting for transmission may include the one or more transceivers 550 and/or antenna 552 of the apparatus 500 in FIG. 5, and/or one or more processors 504 of the apparatus 500 in FIG. 5. Means for communicating, receiving or obtaining may include the one or more transceivers 550 and/or antenna 552 of the apparatus 500 in FIG. 5, and/or one or more processors 504 of the apparatus 500 in FIG. 5.

### Example Clauses

Implementation examples are described in the following numbered clauses:

Clause 1: A method comprising: obtaining a downsampled image of an image of an environment, wherein the downsampled image comprises a plurality of first pixels at a first resolution that is less than a second resolution of the image; generating, with a neural network, for each pixel of the plurality of first pixels, a first respective probability that the pixel is a key point; upsampling the downsampled image to a second image comprising a plurality of second pixels at a third resolution that is greater than the first resolution, wherein each pixel of the plurality of second pixels is associated with a corresponding pixel of the plurality of first pixels and the first respective probability associated with the corresponding pixel; generating, with the neural network, for each pixel of the plurality of second pixels for which the associated first respective probability is greater than a threshold probability, a second respective probability that the pixel is a key point; extracting, for one or more second pixels of the plurality of second pixels for which the associated second respective probability is greater than the threshold probability, a respective descriptor; and executing a localization task configured to utilize the respective descriptor of each of the one or more second pixels.

Clause 2: The method of Clause 1, further comprising: obtaining a map of the environment; and wherein the localization task is based on a comparison of the map of the environment to the second image and the respective descriptor of each of the one or more second pixels.

Clause 3: The method of any one of Clauses 1-2, further comprising: obtaining a third image of the environment; and wherein the localization task is based on a comparison of the third image to the second image and the respective descriptor of each of the one or more second pixels.

Clause 4: The method of any one of Clauses 1-3, further comprising binarizing the respective descriptor of each of the one or more second pixels.

Clause 5: The method of any one of Clauses 1-4, wherein generating the first respective probability for each pixel of the plurality of first pixels comprises generating a heatmap of the downsampled image, wherein pixel values of the heatmap correspond to the first respective probability for each of the plurality of first pixels.

Clause 6: The method of any one of Clauses 1-5, wherein generating the second respective probability for each pixel of the plurality of second pixels for which the associated first respective probability is greater than the threshold probability comprises generating a second heatmap of the second image, wherein pixel values of the second heatmap correspond to the second respective probability of each of the plurality of second pixels for which the associated first respective probability is greater than the threshold probability.

Clause 7: The method of any one of Clauses 1-6, further comprising: generating, with the neural network, a three-dimensional tensor for the second image, wherein the three-dimensional tensor comprises a shape with a height and a width corresponding to the third resolution, and a color channel, and extracting the respective descriptor for the one or more second pixels comprises utilizing bilinear interpolation of the three-dimensional tensor to extract the respective descriptor corresponding to each of the one or more second pixels.

Clause 8: The method of any one of Clauses 1-7, wherein the apparatus includes a processing system that includes one or more processors and one or more memories coupled with the one or more processors, and the apparatus includes a plurality of image sensors communicatively coupled to the one or more processors and the one or more memories, wherein each of the plurality of image sensors are configured to generate respective image data of the environment from different perspectives, and wherein the method further comprises: obtaining a second downsampled image of a third image associated with a different perspective of the environment than the image, wherein the second downsampled image comprises a plurality of third pixels at a fourth resolution that is less than a fifth resolution of the third image; generating, with the neural network, for each pixel of the plurality of third pixels, a third respective probability that the pixel is a key point; determining that the third respective probability of each of at least one of the plurality of third pixels is greater than the threshold probability or that the third respective probability of each of at least one of the plurality of third pixels is not greater than the threshold probability; and in response to a determination that the third respective probability of each of the at least one of the plurality of third pixels is not greater than the threshold probability, discarding the second downsampled image.

Clause 9: The method of any one of Clauses 1-8, wherein the apparatus includes a processing system that includes one or more processors and one or more memories coupled with the one or more processors, and the apparatus includes a plurality of image sensors communicatively coupled to the one or more processors and the one or more memories, wherein each of the plurality of image sensors are configured to generate respective image data of the environment from different perspectives, and wherein the method further comprises: obtaining a second downsampled image of a third image associated with a different perspective of the environment than the image, wherein the second downsampled image comprises a plurality of third pixels at a fourth resolution that is less than a fifth resolution of the third image; generating, with the neural network, for each pixel of the plurality of third pixels, a third respective probability that the pixel is a key point; determining that the third respective probability of each of at least one of the plurality of third pixels is not greater than the threshold probability; and in response to a determination that the third respective probability of the at least one of the plurality of third pixels is greater than the threshold probability: upsampling the second downsampled image to a fourth image comprising a plurality of fourth pixels that is greater than the third resolution, wherein each pixel of the plurality of fourth pixels is associated with a corresponding pixel of the plurality of third pixels and the third respective probability associated with the corresponding pixel; generating, with the neural network, for each pixel of the plurality of fourth pixels for which the associated third respective probability is greater than the threshold probability, a fourth respective probability that the pixel is a key point; extracting, for one or more fourth pixels of the plurality of fourth pixels for which the associated fourth respective probability is greater than the threshold probability, a respective descriptor; and storing the respective descriptor of each of the one or more fourth pixels in the one or more memories of the apparatus.

Clause 10: The method of any one of Clauses 1-9, wherein the third resolution is equivalent to the second resolution of the image.

Clause 11: One or more apparatuses, comprising: one or more memories comprising executable instructions; and one or more processors configured to execute the executable instructions and cause the one or more apparatuses to perform a method in accordance with any one of Clauses 1-10.

Clause 12: One or more apparatuses configured for feature detection and extraction, comprising: one or more memories; and one or more processors, coupled to the one or more memories, configured to cause the one or more apparatuses to perform a method in accordance with any one of Clauses 1-10.

Clause 13: One or more apparatuses configured for feature detection and extraction, comprising: one or more memories; and one or more processors, coupled to the one or more memories, configured to perform a method in accordance with any one of Clauses 1-10.

Clause 14: One or more apparatuses, comprising means for performing a method in accordance with any one of Clauses 1-10.

Clause 15: One or more non-transitory computer-readable media comprising executable instructions that, when executed by one or more processors of one or more apparatuses, cause the one or more apparatuses to perform a method in accordance with any one of Clauses 1-10.

Clause 16: One or more computer program products embodied on one or more computer-readable storage media comprising code for performing a method in accordance with any one of Clauses 1-10.

Clause 17: One or more apparatuses configured for feature detection and extraction, comprising: a processing system that includes one or more processors and one or more memories coupled with the one or more processors, the processing system configured to cause the one or more apparatuses to perform a method in accordance with any one of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising: a processing system that includes one or more processors and one or more memories coupled with the one or more processors, the processing system configured to cause the apparatus to:
obtain a downsampled image of an image of an environment, wherein the downsampled image comprises a plurality of first pixels at a first resolution that is less than a second resolution of the image;
generate, with a neural network, for each pixel of the plurality of first pixels, a first respective probability that the pixel is a key point;
upsample the downsampled image to a second image comprising a plurality of second pixels at a third resolution that is greater than the first resolution, wherein each pixel of the plurality of second pixels is associated with a corresponding pixel of the plurality of first pixels and the first respective probability associated with the corresponding pixel;
generate, with the neural network, for each pixel of the plurality of second pixels for which the associated first respective probability is greater than a threshold probability, a second respective probability that the pixel is a key point;
extract, for one or more second pixels of the plurality of second pixels for which the associated second respective probability is greater than the threshold probability, a respective descriptor; and
execute a localization task configured to utilize the respective descriptor of each of the one or more second pixels.

2. The apparatus of claim 1, wherein the processing system is configured to cause the apparatus to:
obtain a map of the environment; and
wherein the localization task is based on a comparison of the map of the environment to the second image and the respective descriptor of each of the one or more second pixels.

3. The apparatus of claim 1, wherein the processing system is configured to cause the apparatus to:
obtain a third image of the environment; and
wherein the localization task is based on a comparison of the third image to the second image and the respective descriptor of each of the one or more second pixels.

4. The apparatus of claim 1, wherein the processing system is configured to cause the apparatus to binarize the respective descriptor of each of the one or more second pixels.

5. The apparatus of claim 1, wherein to generate the first respective probability for each pixel of the plurality of first pixels comprises causing the apparatus to generate a heatmap of the downsampled image, wherein pixel values of the heatmap correspond to the first respective probability for each of the plurality of first pixels.

6. The apparatus of claim 1, wherein to generate the second respective probability for each pixel of the plurality of second pixels for which the associated first respective probability is greater than the threshold probability comprises causing the apparatus to generate a second heatmap of the second image, wherein pixel values of the second heatmap correspond to the second respective probability of each of the plurality of second pixels for which the associated first respective probability is greater than the threshold probability.

7. The apparatus of claim 1, wherein:
the processing system is configured to cause the apparatus to generate, with the neural network, a three-dimensional tensor for the second image, wherein the three-dimensional tensor comprises a shape with a height and a width corresponding to the third resolution, and a color channel, and
to extract the respective descriptor for the one or more second pixels, the processing system is configured to cause the apparatus to utilize bilinear interpolation of the three-dimensional tensor to extract the respective descriptor corresponding to each of the one or more second pixels.

8. The apparatus of claim 1, further comprising a plurality of image sensors communicatively coupled to the one or more processors and the one or more memories, wherein each of the plurality of image sensors are configured to generate respective image data of the environment from different perspectives, and
wherein the processing system is configured to cause the apparatus to:
obtain a second downsampled image of a third image associated with a different perspective of the environment than the image, wherein the second downsampled image comprises a plurality of third pixels at a fourth resolution that is less than a fifth resolution of the third image;
generate, with the neural network, for each pixel of the plurality of third pixels, a third respective probability that the pixel is a key point;
determine that the third respective probability of each of at least one of the plurality of third pixels is greater than the threshold probability or that the third respective probability of each of at least one of the plurality of third pixels is not greater than the threshold probability; and
in response to a determination that the third respective probability of each of the at least one of the plurality of third pixels is not greater than the threshold probability, discard the second downsampled image.

9. The apparatus of claim 1, further comprising a plurality of image sensors communicatively coupled to the one or more processors and the one or more memories, wherein each of the plurality of image sensors are configured to generate respective image data of the environment from different perspectives, and
wherein the processing system is configured to cause the apparatus to:
obtain a second downsampled image of a third image associated with a different perspective of the environment than the image, wherein the second downsampled image comprises a plurality of third pixels at a fourth resolution that is less than a fifth resolution of the third image;
generate, with the neural network, for each pixel of the plurality of third pixels, a third respective probability that the pixel is a key point;
determine that the third respective probability of each of at least one of the plurality of third pixels is not greater than the threshold probability; and
in response to a determination that the third respective probability of the at least one of the plurality of third pixels is greater than the threshold probability:
upsample the second downsampled image to a fourth image comprising a plurality of fourth pixels that is greater than the third resolution, wherein each pixel of the plurality of fourth pixels is associated with a corresponding pixel of the plurality of third pixels and the third respective probability associated with the corresponding pixel;
generate, with the neural network, for each pixel of the plurality of fourth pixels for which the associated third respective probability is greater than the threshold probability, a fourth respective probability that the pixel is a key point;
extract, for one or more fourth pixels of the plurality of fourth pixels for which the associated fourth respective probability is greater than the threshold probability, a respective descriptor; and
store the respective descriptor of each of the one or more fourth pixels in the one or more memories of the apparatus.

10. The apparatus of claim 1, wherein the third resolution is equivalent to the second resolution of the image.

11. A method for feature detection and extraction by an apparatus, comprising:
obtaining a downsampled image of an image of an environment, wherein the downsampled image comprises a plurality of first pixels at a first resolution that is less than a second resolution of the image;
generating, with a neural network, for each pixel of the plurality of first pixels, a first respective probability that the pixel is a key point;
upsampling the downsampled image to a second image comprising a plurality of second pixels at a third resolution that is greater than the first resolution, wherein each pixel of the plurality of second pixels is associated with a corresponding pixel of the plurality of first pixels and the first respective probability associated with the corresponding pixel;
generating, with the neural network, for each pixel of the plurality of second pixels for which the associated first respective probability is greater than a threshold probability, a second respective probability that the pixel is a key point;
extracting, for one or more second pixels of the plurality of second pixels for which the associated second respective probability is greater than the threshold probability, a respective descriptor; and
executing a localization task configured to utilize the respective descriptor of each of the one or more second pixels.

12. The method of claim 11, further comprising:
obtaining a map of the environment; and
wherein the localization task is based on a comparison of the map of the environment to the second image and the respective descriptor of each of the one or more second pixels.

13. The method of claim 11, further comprising:
obtaining a third image of the environment; and
wherein the localization task is based on a comparison of the third image to the second image and the respective descriptor of each of the one or more second pixels.

14. The method of claim 11, further comprising binarizing the respective descriptor of each of the one or more second pixels.

15. The method of claim 11, wherein generating the first respective probability for each pixel of the plurality of first pixels comprises generating a heatmap of the downsampled image, wherein pixel values of the heatmap correspond to the first respective probability for each of the plurality of first pixels.

16. The method of claim 11, wherein generating the second respective probability for each pixel of the plurality of second pixels for which the associated first respective probability is greater than the threshold probability comprises generating a second heatmap of the second image, wherein pixel values of the second heatmap correspond to the second respective probability of each of the plurality of second pixels for which the associated first respective probability is greater than the threshold probability.

17. The method of claim 11, further comprising:
generating, with the neural network, a three-dimensional tensor for the second image, wherein the three-dimensional tensor comprises a shape with a height and a width corresponding to the third resolution, and a color channel, and
extracting the respective descriptor for the one or more second pixels comprises utilizing bilinear interpolation of the three-dimensional tensor to extract the respective descriptor corresponding to each of the one or more second pixels.

18. The method of claim 11, wherein the apparatus includes a plurality of image sensors communicatively coupled to one or more processors and one or more memories of the apparatus, wherein each of the plurality of image sensors are configured to generate respective image data of the environment from different perspectives, and
wherein the method further comprises:
obtaining a second downsampled image of a third image associated with a different perspective of the environment than the image, wherein the second downsampled image comprises a plurality of third pixels at a fourth resolution that is less than a fifth resolution of the third image;
generating, with the neural network, for each pixel of the plurality of third pixels, a third respective probability that the pixel is a key point;
determining that the third respective probability of each of at least one of the plurality of third pixels is greater than the threshold probability or that the third respective probability of each of at least one of the plurality of third pixels is not greater than the threshold probability; and
in response to a determination that the third respective probability of each of the at least one of the plurality of third pixels is not greater than the threshold probability, discarding the second downsampled image.

19. The method of claim 11, wherein the apparatus includes a plurality of image sensors communicatively coupled to one or more processors and th one or more memories of the apparatus, wherein each of the plurality of image sensors are configured to generate respective image data of the environment from different perspectives, and
wherein the method further comprises:
obtaining a second downsampled image of a third image associated with a different perspective of the environment than the image, wherein the second downsampled image comprises a plurality of third pixels at a fourth resolution that is less than a fifth resolution of the third image;
generating, with the neural network, for each pixel of the plurality of third pixels, a third respective probability that the pixel is a key point;
determining that the third respective probability of each of at least one of the plurality of third pixels is not greater than the threshold probability; and
in response to a determination that the third respective probability of the at least one of the plurality of third pixels is greater than the threshold probability:
upsampling the second downsampled image to a fourth image comprising a plurality of fourth pixels that is greater than the third resolution, wherein each pixel of the plurality of fourth pixels is associated with a corresponding pixel of the plurality of third pixels and the third respective probability associated with the corresponding pixel;
generating, with the neural network, for each pixel of the plurality of fourth pixels for which the associated third respective probability is greater than the threshold probability, a fourth respective probability that the pixel is a key point;
extracting, for one or more fourth pixels of the plurality of fourth pixels for which the associated fourth respective probability is greater than the threshold probability, a respective descriptor; and
storing the respective descriptor of each of the one or more fourth pixels in the one or more memories of the apparatus.

20. The method of claim 11, wherein the third resolution is equivalent to the second resolution of the image.
